(19) United States
(12) Patent Application Publication
(10) Pub. No.: US 2002/0066751 A1
(43) Pub. Date: Jun. 6, 2002

(54) CONTAINER WITH SNAP-ON NECK

(76) Inventor: Philip Meshberg, Palm Beach, FL (US)

Correspondence Address: KENYON & KENYON, ONE BROADWAY, NEW YORK, NY, 10004, US

(21) Appl. No.: 09/502,767

(22) Filed: Feb. 11, 2000

Related U.S. Application Data
(63) Continuation-in-part of application No. 08/947,460, filed on Oct. 17, 1997.

(30) Foreign Application Priority Data
Dec. 30, 1996 (US) 08774338
Apr. 10, 1995 (US) 08419499

(51) Int. Cl. G01F 11/06; G01F 11/30

(52) U.S. Cl. 222/153.13

(57) ABSTRACT

An integrally formed container for complementary use with a mounting cup comprising a neck portion including an interior sealing surface adapted to contact an interior piston portion of a mounting cup and an exterior surface including a lower snap surface adapted to engage the upper snap surface of an exterior snap flange on the mounting cup and a rim surface forming a mouth and disposed between the interior sealing surface of said neck portion and the exterior surface of said neck portion.

This application is a continuation-in-party of U.S. patent application Ser. No. 08/947,460, filed Oct. 17, 1997, which is a continuation-in-part of U.S. patent application Ser. No. 08/774,338, filed Dec. 30, 1996, now U.S. Pat. No. 5,875,932, which is a division of U.S. patent application Ser. No. 08/419,499, filed Apr. 10, 1995, now U.S. Pat. No. 5,620,113, issued Apr. 15, 1997.

### BACKGROUND OF THE INVENTION

1. Field of the Invention

The present invention relates to a complete dispensing package designed to be shipped as an assembled unit to a liquid product marketer, for subsequent filling. The dispensing package is easily filled and top or bottom sealed with a minimal number of automatic assembly steps. The package of the present invention also provides a tamper-resistant package. In one embodiment of the present invention, a mounting cup for mounting the pump to the container, which may be blow-molded, without the need for screw threads or crimping. The relationship between the container and the mounting cup forms an effective seal.

2. Description of the Prior Art

U.S. Pat. No. 4,228,931 discloses manually operated pump for use with a container. The container includes a mouth with an outwardly connecting annual rib. The container is used with a head having an inwardly projecting annular rib. The inwardly projecting annular rib of the head is snap connected to the outwardly projecting rib of the container. In the device disclosed in U.S. Pat. No. 4,228,931, when the container and head engage, the rim of the container does not contact the head. Moreover, the surface of the rim that engages with the interior of the container are not substantially parallel to each other. Accordingly, in the device of U.S. Pat. No. 4,228,931, the interface between the container and the head fails to form an effective seal.

### SUMMARY OF INVENTION

The present invention is a container for use with a package-dispensing unit combination designed for easy filling and post-filling assembly, and which can be efficiently shipped to a liquid product producer and to a post-filling marketer. The device of the present invention is especially suitable for promotional purposes, since the liquid product producer need only fill the package and snap on a bottom piece or a mounting cup to the package, which may be labeled before or after the filling process. The device of the present invention is ideally suited for allowing directional dispensing of liquid products. The device is thus particularly suited to a quick-turnaround filling and marketing operation, and the assembled and filled packages can be shipped in the same cartons as the unfilled packages were shipped to the liquid product producer. Accordingly, the present invention eliminates waste in carton usage, preventing the need to use different cartons for the containers, pumps and the filled package.

The present invention includes an embodiment with a mounting cup is used to secure the pump to the package, and the mounting cup is structured to snap onto the neck of the package which package may be blow-molded. This design obviates the need for either a screw-threaded mounting cup for mounting the pump to the package, or the use of conventional crimping techniques. The mounting cup of the present invention may be easily snapped on, while still providing effective sealing of the contents within the package.

### BRIEF DESCRIPTION OF THE DRAWINGS

Other objects and advantages of the invention will be apparent from the specification and claims, when considered in connection with the attached sheets of drawings, illustrating one form of the invention, wherein like characters represent like parts and in which:

FIG. 1 is a partial cross-sectional view of an embodiment of a container of the present invention;

FIG. 2 is a partial cross-sectional detail view of the embodiment of FIG. 8;

FIGS. 3-6 are, respectively, top, front, side and rear views of the embodiment of FIG. 8;

FIGS. 7-8 are, respectively, the cross-sectional and side views of the bottle illustrated in FIG. 8; the dimensions are exemplary; and

FIG. 9 is a corresponding view of FIG. 8 illustrating exemplary dimensions that result in effective sealing.

### DETAILED DESCRIPTION OF THE DRAWINGS

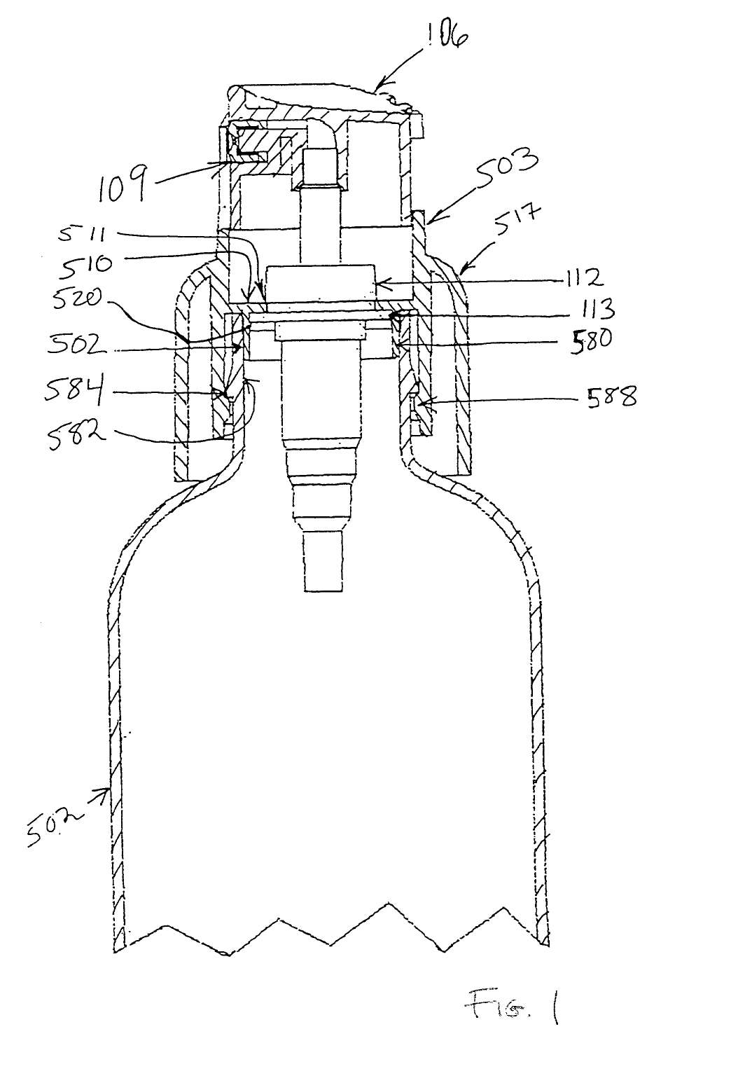

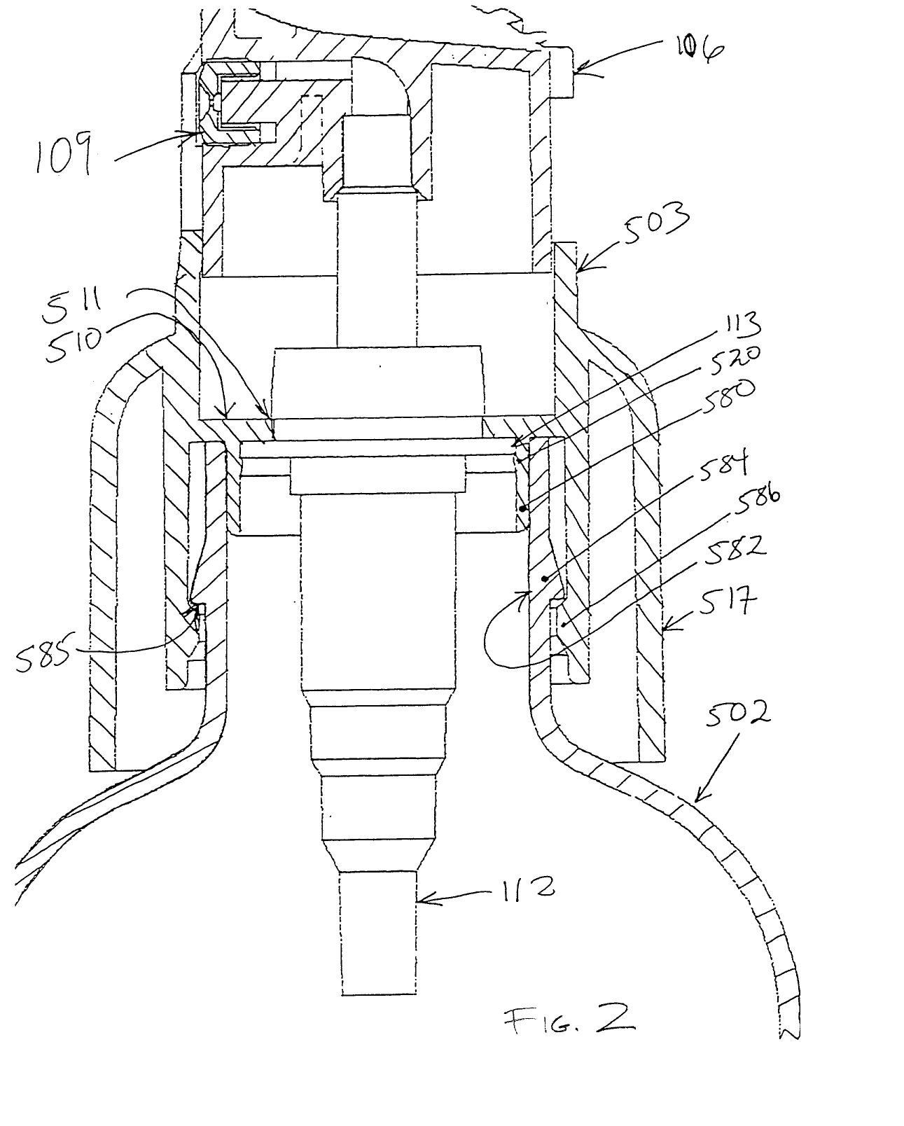

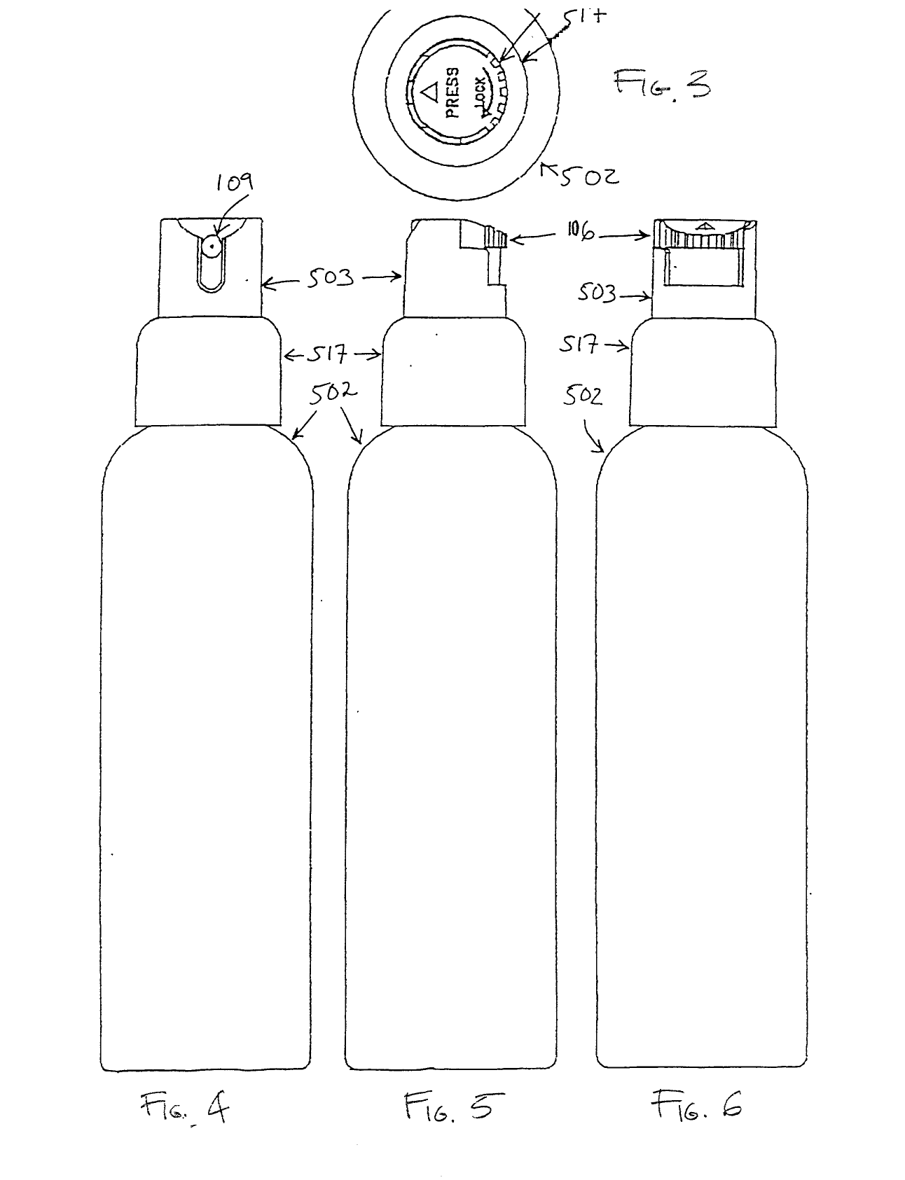

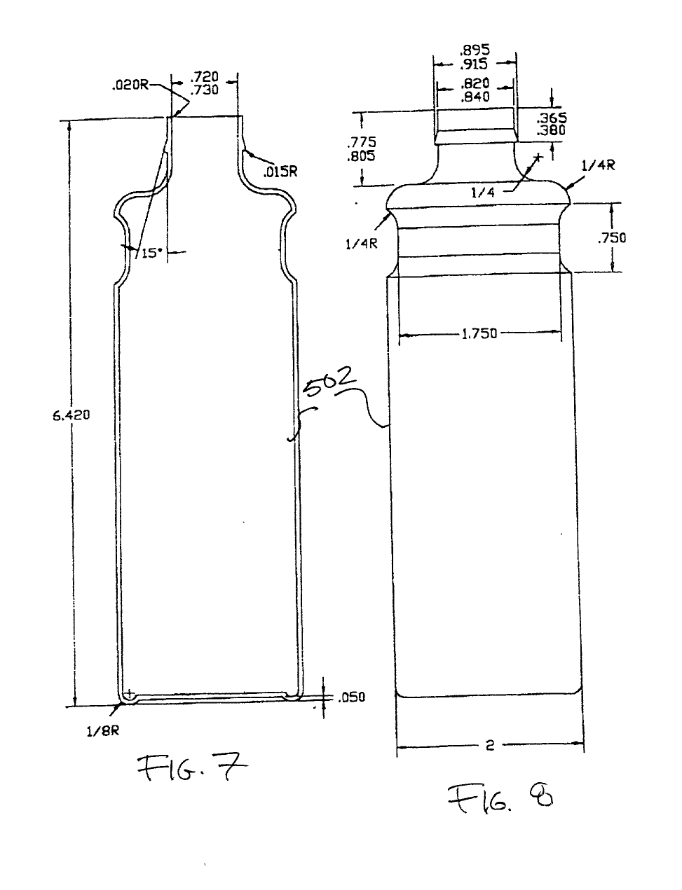

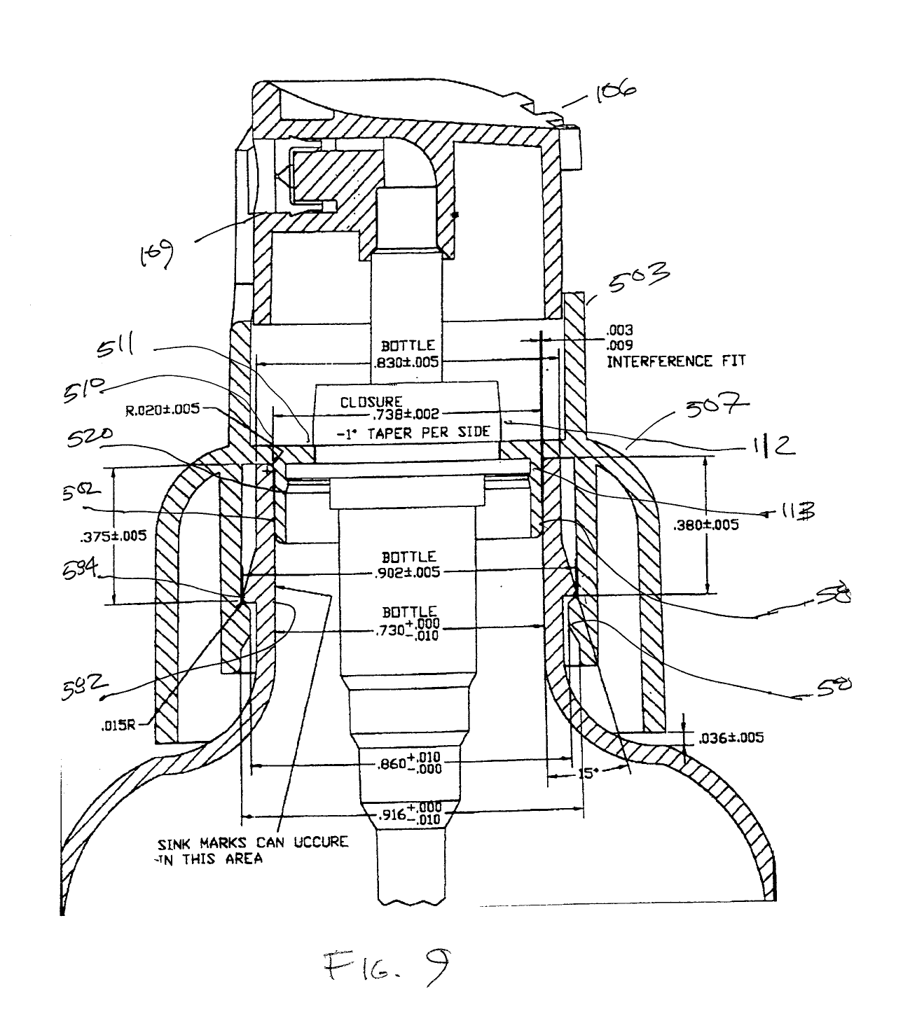

FIGS. 1-9 show an embodiment of the present invention. The illustrated embodiment of FIGS. 1-9 is also useful for larger-size bottles or containers, in which the container portion 502 of the package 501 may be made by manufacturing techniques other than injection molding, such as blow-molding.

The embodiment of FIGS. 1-9 also includes a mounting cup 517 for mounting a pump 112 to the upper end of container portion 502. Mounting cup 517 includes a retaining wall 510 including a retaining opening 511 used to secure a pump 112 in the mounting cup 517. Pump 112 can be of any conventional design. Pump 112 includes a retention flange 113 which snaps into a retaining groove between retaining wall 510 and a retaining bead 520 on the interior piston portion 580. Pump 112 is inserted into retaining opening 511 through the lower end of mounting cup 517.

The mounting cup 517 in the embodiment of FIGS. 8-13 is particularly effective in ensuring a leakproof and easy-to-assemble mounting of pump 112 onto container portion 502 without the need for complicated molding of container portion 502. In addition, the design of mounting cup 517 is such that it does not require a gasket between the mounting cup 517 and the container portion 502 or between the pump 112 and the mounting cup 517. Mounting cup 517 includes an interior piston portion 580, which slides in and seals against an interior sealing surface 582 of container portion 502. Interior piston portion 580 may be tapered radially outwardly. Container portion 502 also includes, at its upper end, angled snap rim 584 extending around the entire circumference of container portion 502, and which is axially spaced from the end of the container portion 502 neck. Snap rim 584 includes a lower snap surface 585. Mounting cup 517 includes an exterior snap flange 586 which is used to secure and seal mounting cup 517 to container portion 502.

The interior piston portion 580 provides sufficient sealing between mounting cup 517 and container portion 502 so as to eliminate the need for a gasket between the container portion 502 and mounting cup 517. The tapering of interior piston portion 580, which causes a slight interference fit, allows good sealing contact between the mounting cup 517 and the container portion 502. In addition, the slight interference fit causes the interior piston portion 580 to be squeezed inwardly upon insertion into container portion 502, thereby more securely holding retention flange 113 in the groove between retaining wall 510 and retaining bead 520. Interior piston portion 580 also causes improved sealing upon increase of pressure in the interior of container portion 502, as the result of pressure acting on the interior circumference of interior piston portion 580.

As shown in FIGS. 1-9, an actuator 106 is mounted on pump 112 and surrounded by an upstanding wall 503 on mounting cup 517. Actuator 106 can include a nozzle 109.

Of course, it will be recognized by those skilled in the art that a variety of variations may be made in the construction of the above invention without departing from the claims. As such, the scope of the above invention is be limited only by the claims appended hereto.

What is claimed is:

1. An integrally formed container for complementary use with a mounting cup, comprising:
a neck portion including
an interior sealing surface adapted to contact an interior piston portion of a mounting cup; and
an exterior surface including a lower snap surface adapted to engage the upper snap surface of an exterior snap flange on the mounting cup; and
a rim surface forming a mouth and disposed between the interior sealing surface of said neck portion and the exterior surface of said neck portion.

2. The container of claim 1, wherein:
the contact between the interior sealing surface of the neck portion and the interior piston portion of the mounting cup is adapted to be an interference fit.

3. The container of claim 1, wherein:
the interior sealing surface of the neck portion is adapted to form an angle between the interior piston portion of the mounting cup.

4. The container of claim 3, wherein:
the angle is less than approximately five degrees.

5. The container of claim 4, wherein:
the angle is approximately one degree.

6. The container of claim 1, wherein:
said rim surface engages with a surface of the mounting cup disposed between the interior piston portion and the exterior snap flange.

7. The container of claim 1, wherein:
a first axial distance, existing between said rim surface and the lower snap surface of said exterior surface, is greater than a second axial distance, forming the length of the interior piston portion of the mounting cup.

8. The container of claim 7, wherein:
the first distance is substantially between 0.365 and 0.38 inches.

9. The container of claim 1, wherein:
said exterior surface further includes an upper snap surface.

10. The container of claim 9, wherein:
the upper snap surface of said exterior surface forms an angle between the interior sealing surface of said neck portion.

11. The container of claim 10, wherein:
the angle is approximately 15 degrees.

12. The container of claim 1, wherein:
the interior sealing surface has a diameter substantially between 0.72 and 0.73 inches.

13. The container of claim 1, wherein:
the exterior surface has a diameter substantially between 0.82 and 0.84 inches in the axial portion near said rim surface.
